(19) United States
(12) Patent Application Publication
(10) Pub. No.: US 2025/0059085 A1
(43) Pub. Date: Feb. 20, 2025

(54) RESIN COMPOSITION FOR OPTICAL FIBER COATING, COLORED COATING MATERIAL FOR OPTICAL FIBER, OPTICAL FIBER, AND OPTICAL FIBER RIBBON

(71) Applicant: SUMITOMO ELECTRIC INDUSTRIES, LTD., Osaka (JP)

(72) Inventors: Katsushi HAMAKUBO, Osaka (JP); Noriaki IWAGUCHI, Osaka (JP); Miho IKEGAWA, Osaka (JP); Chiaki TOKUDA, Osaka (JP); Tatsuya KONISHI, Osaka (JP)

(21) Appl. No.: 18/754,379

(22) Filed: Jun. 26, 2024

(30) Foreign Application Priority Data
Aug. 15, 2023 (JP) 2023-132291

(51) Int. Cl. C03C 25/105; C03C 25/1065; C03C 25/285; C03C 25/47; C03C 25/475

(52) U.S. Cl. CPC C03C 25/105; C03C 25/1065; C03C 25/285; C03C 25/47; C03C 25/475

(57) ABSTRACT

A resin composition for optical fiber coating contains a photopolymerizable compound, a photopolymerization initiator, and surface-treated copper phthalocyanine particles, in which a content of the surface-treated copper phthalocyanine particles is 0.1% by mass or more and 10% by mass or less based on the total amount of the resin composition.

### CROSS-REFERENCE TO RELATED APPLICATIONS

This application claims priority to Japanese Patent Application No. 2023-132291 filed Aug. 15, 2023, the entire content of which is incorporated herein by reference.

### TECHNICAL FIELD

The present disclosure relates to a resin composition for optical fiber coating, a colored coating material for an optical fiber, an optical fiber, and an optical fiber ribbon.

### BACKGROUND

An optical fiber has generally a coating resin layer for protecting a glass fiber that is an optical transmission medium. The coating resin layer has, for example, a primary resin layer and a secondary resin layer. An outermost layer of the coating resin layer is configured by a colored resin layer for identifying the optical fiber (see, for example, JP H6-242355 A, JP 2003-279811 A, and I WO 2016/047002 A1).

### SUMMARY

A resin composition for optical fiber coating according to one aspect of the present disclosure contains a photopolymerizable compound, a photopolymerization initiator, and surface-treated copper phthalocyanine particles, in which a content of the surface-treated copper phthalocyanine particles is 0.1% by mass or more and 10% by mass or less based on the total amount of the resin composition.

### BRIEF DESCRIPTION OF THE DRAWINGS

FIG. 1 is a schematic cross-sectional view illustrating an example of an optical fiber according to the present embodiment.

FIG. 2 is a schematic cross-sectional view illustrating an example of an optical fiber according to the present embodiment.

FIG. 3 is a schematic cross-sectional view illustrating an example of an optical fiber ribbon according to the present embodiment.

### DETAILED DESCRIPTION

An optical fiber may be used in the form of an optical fiber ribbon including a plurality of optical fibers arranged and collectively integrated with a ribbon resin. In an optical fiber ribbon using an optical fiber having a colored resin layer, when there are convex portions on the surface of the colored resin layer, adhesion between the colored resin layer and a ribbon material becomes locally stronger, and when an operation of taking out the optical fiber by removing a ribbon material is performed, a phenomenon that the colored resin layer is peeled off from the optical fiber, that is, so-called “color peeling” may occur.

An object of the present disclosure is to provide a resin composition for optical fiber coating by which an optical fiber in which color peeling is less likely to occur can be produced, a colored coating material for an optical fiber, an optical fiber, and an optical fiber ribbon.

According to the present disclosure, it is possible to provide a resin composition for optical fiber coating by which an optical fiber in which color peeling is less likely to occur can be produced, a colored coating material for an optical fiber, an optical fiber, and an optical fiber ribbon. First, the contents of embodiments of the present disclosure will be listed and described.
(1) A resin composition for optical fiber coating according to one aspect of the present disclosure contains a photopolymerizable compound, a photopolymerization initiator, and surface-treated copper phthalocyanine particles, in which a content of the surface-treated copper phthalocyanine particles is 0.1% by mass or more and 10% by mass or less based on the total amount of the resin composition.

When such a resin composition contains surface-treated copper phthalocyanine particles in a specific range, an optical fiber in which color peeling is less likely to occur can be produced.
(2) In the above (1), from the viewpoint of making occurrence of color peeling more difficult, the surface-treated copper phthalocyanine particles may have a surface-treated layer derived from a rosin compound containing at least one selected from the group consisting of abietic acid, dehydroabietic acid, and tetrahydroabietic acid.
(3) In the above (1) or (2), from the viewpoint of dispersibility, an amount of the surface-treated layer in the surface-treated copper phthalocyanine particles may be 1% by mass or more and 20% by mass or less.
(4) In any one of the above (1) to (3), from the viewpoint of increasing the strength of the resin layer, the photopolymerizable compound may contain epoxy di(meth)acrylate.
(5) A colored coating material for an optical fiber according to one aspect of the present disclosure contains the resin composition described in any one of the above (1) to (4). By using the resin composition according to the present embodiment in the colored resin layer, an optical fiber in which color peeling is less likely to occur can be produced.
(6) An optical fiber according to one aspect of the present disclosure includes a glass fiber including a core and a cladding, a primary resin layer being in contact with the glass fiber and coating the glass fiber, a secondary resin layer coating the primary resin layer, and a colored resin layer coating the secondary resin layer, in which the colored resin layer contains a cured product of the resin composition described in any one of the above (1) to (4). In such an optical fiber, color peeling is less likely to occur.
(7) An optical fiber according to one aspect of the present disclosure includes a glass fiber including a core and a cladding, a primary resin layer being in contact with the glass fiber and coating the glass fiber, and a secondary resin layer coating the primary resin layer, in which the secondary resin layer contains a cured product of the resin composition described in any one of the above (1) to (4). In such an optical fiber, color peeling is less likely to occur.
(8) An optical fiber ribbon according to one aspect of the present disclosure in which a plurality of optical fibers described in the above (6) or (7) are arranged in parallel and coated with a ribbon resin. In such an optical fiber ribbon, when an operation of taking out the optical fiber is performed, color peeling is less likely to occur, and the optical fiber can be easily identified.

Specific examples of a resin composition, an optical fiber, and an optical fiber ribbon according to embodiments of the present disclosure will be described with reference to the drawings as necessary. Note that, the present disclosure is not limited to these illustrations but is indicated by the claims and intended to include meanings equivalent to the claims and all modifications within the claims. In the following description, the same reference numerals are given to the same elements in the description of the drawing, and redundant description will be omitted. In the present specification, (meth)acrylate means an acrylate or its corresponding methacrylate. The same applies to other similar expressions such as (meth)acryloyl.

### (Resin Composition)

A resin composition for optical fiber coating according to the present embodiment contains a photopolymerizable compound, a photopolymerization initiator, and surface-treated copper phthalocyanine particles, in which a content of the surface-treated copper phthalocyanine particles is 0.1% by mass or more and 10% by mass or less based on the total amount of the resin composition.

It is known that copper phthalocyanine particles are added as an organic pigment when a colored resin layer is formed on an optical fiber. However, when the dispersion state of the copper phthalocyanine particles is poor, irregularities occur on the surface of the optical fiber, and color peeling may occur in some cases. On the other hand, the surface-treated copper phthalocyanine particles can improve the dispersibility in the resin composition.

As the surface-treated copper phthalocyanine particles, for example, those obtained by treating copper phthalocyanine particles with a surface treatment agent containing a rosin compound can be used. The surface-treated copper phthalocyanine particles may have a surface-treated layer derived from a rosin compound. The rosin compound contains components such as abietic acid, dehydroabietic acid, and tetrahydroabietic acid. When the surface-treated copper phthalocyanine particles have a surface-treated layer derived from a rosin compound containing at least one selected from the group consisting of abietic acid, dehydroabietic acid, and tetrahydroabietic acid, the dispersibility can be further improved. The surface-treated layer may be formed on at least a portion of the surface of the copper phthalocyanine particles, and may be formed on the entire surface of the copper phthalocyanine particles.

The amount of the surface-treated layer in the surface-treated copper phthalocyanine particles may be 1% by mass or more, 2% by mass or more, 3% by mass or more, or 4% by mass or more from the viewpoint of further improving dispersibility, and may be 20% by mass or less, 15% by mass or less, 10% by mass or less, 8% by mass or less, or 6% by mass or less from the viewpoint of enhancing hiding power. The amount of the surface-treated layer can be calculated by analyzing the surface-treated copper phthalocyanine particles using a pyrolysis gas chromatograph mass spectrometer.

From the viewpoint of further improving dispersibility, the average particle diameter of the surface-treated copper phthalocyanine particles may be 1000 nm or less, 800 nm or less, 500 nm or less, 300 nm or less, 200 nm or less, or 150 nm or less. From the viewpoint of enhancing coloring power, the average particle diameter of the surface-treated copper phthalocyanine particles may be 1 nm or more, 10 nm or more, 50 nm or more, or 80 nm or more, and may be 50 nm or more and 300 nm or less. The average particle diameter can be measured, for example, by image analysis of electron micrographs, a light scattering method, a BET method, or the like.

From the viewpoint of improving the visibility of the resin layer, the content of the surface-treated copper phthalocyanine particles may be 0.2% by mass or more, 0.4% by mass or more, 0.6% by mass or more, or 0.8% by mass or more, based on the total amount of the resin composition. From the viewpoint of further improving dispersibility, the content of the surface-treated copper phthalocyanine particles may be 9% by mass or less, 8% by mass or less, 7% by mass or less, or 6% by mass or less, based on the total amount of the resin composition.

The photopolymerizable compound is not particularly limited, and may contain epoxy di(meth)acrylate from the viewpoint of increasing the strength of the resin layer. As the epoxy di(meth)acrylate, a reaction product of a diglycidyl ether compound having a bisphenol skeleton and a compound having a (meth)acryloyl group such as (meth)acrylic acid can be used. The epoxy di(meth)acrylate may be used singly or as a mixture of two or more kinds thereof.

Examples of the epoxy di(meth)acrylate include a (meth)acrylic acid adduct of bisphenol A diglycidyl ether, a (meth)acrylic acid adduct of bisphenol AF diglycidyl ether, and a (meth)acrylic acid adduct of bisphenol F diglycidyl ether.

From the viewpoint of further increasing the strength of the resin layer, the content of the epoxy di(meth)acrylate may be 30 parts by mass or more, 40 parts by mass or more, or 45 parts by mass or more, and may be 70 parts by mass or less, 65 parts by mass or less, or 60 parts by mass or less, with respect to 100 parts by mass of the total amount of the photopolymerizable compound.

From the viewpoint of adjusting the Young's modulus of the resin layer, the photopolymerizable compound may further contain urethane (meth)acrylate. As the urethane (meth)acrylate, for example, a reaction product of a polyol compound, a polyisocyanate compound, and a hydroxyl group-containing (meth)acrylate compound can be used. The urethane (meth)acrylate may be used singly or as a mixture of two or more kinds thereof.

Examples of the polyol compound include polytetramethylene glycol, polypropylene glycol, and bisphenol A-ethylene oxide addition diol. Examples of the polyisocyanate compound include 2,4-tolylene diisocyanate, 2,6-tolylene diisocyanate, isophorone diisocyanate, and dicyclohexylmethane 4,4′-diisocyanate. Examples of the hydroxyl group-containing (meth)acrylate compound include 2-hydroxyethyl(meth)acrylate, 2-hydroxybutyl(meth)acrylate, 1,6-hexanediol mono(meth)acrylate, pentaerythritol tri(meth)acrylate, 2-hydroxypropyl(meth)acrylate, and tripropylene glycol mono(meth)acrylate.

From the viewpoint of adjusting the Young's modulus of the resin layer, the number average molecular weight (Mn) of the polyol compound may be 300 or more and 3000 or less, 400 or more and 3000 or less, or 500 or more and 2500 or less.

As a catalyst when the urethane (meth)acrylate is synthesized, an organotin compound is generally used. Examples of the organotin compound include dibutyltin dilaurate, dibutyltin diacetate, dibutyltin maleate, dibutyltin bis(2-ethylhexyl mercaptoacetate), dibutyltin bis(isooctyl mercaptoacetate), and dibutyltin oxide. From the viewpoint of easy availability or catalyst performance, dibutyltin dilaurate or dibutyltin diacetate may be used as a catalyst.

A lower alcohol having 5 or less carbon atoms may be used when the urethane (meth)acrylate is synthesized. Examples of the lower alcohol include methanol, ethanol, 1-propanol, 2-propanol, 1-butanol, 2-butanol, 2-methyl-2-propanol, 1-pentanol, 2-pentanol, 3-pentanol, 2-methyl-1-butanol, 3-methyl-1-butanol, 2-methyl-2-butanol, 3-methyl-2-butanol, and 2,2-dimethyl-1-propanol.

The photopolymerizable compound can further contain a photopolymerizable compound (hereinafter, referred to as “monomer”) other than the epoxy di(meth)acrylate and the urethane (meth)acrylate.

Examples of the monomer include a monofunctional monomer having one polymerizable group and a polyfunctional monomer having two or more polymerizable groups. The monomer may be used singly or as a mixture of two or more kinds thereof.

Examples of the monofunctional monomer include (meth)acrylate-based monomers such as methyl(meth)acrylate, ethyl(meth)acrylate, propyl(meth)acrylate, n-butyl(meth)acrylate, s-butyl(meth)acrylate, tert-butyl(meth)acrylate, isobutyl(meth)acrylate, n-pentyl(meth)acrylate, isopentyl(meth)acrylate, hexyl(meth)acrylate, heptyl(meth)acrylate, isoamyl(meth)acrylate, 2-ethylhexyl(meth)acrylate, n-octyl(meth)acrylate, isooctyl(meth)acrylate, isodecyl(meth)acrylate, lauryl(meth)acrylate, 2-phenoxyethyl(meth)acrylate, 3-phenoxy benzyl acrylate, phenoxy diethyleneglycol acrylate, phenoxy polyethylene glycol acrylate, 4-tert-butylcyclohexanol acrylate, tetrahydrofurfuryl(meth)acrylate, benzyl(meth)acrylate, dicyclopentenyl(meth)acrylate, dicyclopentenyloxyethyl(meth)acrylate, dicyclopentanyl (meth)acrylate, nonylphenol polyethylene glycol (meth)acrylate, nonylphenoxypolyethylene glycol (meth)acrylate, and isobornyl (meth)acrylate; carboxy group-containing monomers such as (meth)acrylic acid, a (meth)acrylic acid dimer, carboxyethyl(meth)acrylate, carboxypentyl(meth)acrylate, and ω-carboxy-polycaprolactone (meth)acrylate; heterocycle-containing monomers such as N-(meth)acryloylmorpholine, N-vinylpyrrolidone, N-vinylcaprolactam, N-(meth)acryloylpiperidine, N-(meth)acryloylpyrrolidine, 3-(3-pyridine) propyl(meth)acrylate, and cyclic trimethylolpropane formal acrylate; maleimide-based monomers such as maleimide, N-cyclohexylmaleimide, and N-phenylmaleimide; amide-based monomers such as (meth)acrylamide, N,N-dimethyl(meth)acrylamide, N,N-diethyl(meth)acrylamide, N-hexyl(meth)acrylamide, N-methyl(meth)acrylamide, N-ethyl(meth)acrylamide, N-butyl(meth)acrylamide, N-methylol (meth)acrylamide, and N-methylolpropane (meth)acrylamide; aminoalkyl (meth)acrylate-based monomers such as aminoethyl(meth)acrylate, aminopropyl(meth)acrylate, N,N-dimethylaminoethyl(meth)acrylate, and tert-butylaminoethyl (meth)acrylate; and succinimide-based monomers such as N-(meth)acryloyloxymethylene succinimide, N-(meth)acryloyl-6-oxyhexamethylene succinimide, and N-(meth)acryloyl-8-oxyoctamethylene succinimide.

Examples of the polyfunctional monomer include polyethylene glycol di(meth)acrylate, isocyanuric acid ethylene oxide-modified di(meth)acrylate, ethylene oxide-modified bisphenol F di(meth)acrylate, ethylene oxide-modified bisphenol A di(meth)acrylate, polypropylene glycol di(meth)acrylate, propylene oxide-modified bisphenol A di(meth)acrylate, propylene oxide-modified neopentyl glycol di(meth)acrylate, polytetraethylene glycol di(meth)acrylate, hydroxypivalic acid neopentyl glycol di(meth)acrylate, 1,4-butanediol di(meth)acrylate, 1,6-hexanediol di(meth)acrylate, 1,9-nonanediol di(meth)acrylate, 1,12-dodecanediol di(meth)acrylate, 1,14-tetradecanediol di(meth)acrylate, 1,16-hexadecanediol di(meth)acrylate, 1,20-eicosanediol di(meth)acrylate, neopentyl glycol di(meth)acrylate, isopentyldiol di(meth)acrylate, 3-ethyl-1,8-octanediol di(meth)acrylate; trimethylolpropane tri(meth)acrylate, trimethyloloctane tri(meth)acrylate, trimethylolpropane polyethoxy tri(meth)acrylate, trimethylolpropane polypropoxy tri(meth)acrylate, trimethylolpropane polyethoxy polypropoxy tri(meth)acrylate, tris [(meth)acryloyloxyethyl] isocyanurate, pentaerythritol tri(meth)acrylate, pentaerythritol polyethoxy tetra(meth)acrylate, pentaerythritol polypropoxy tetra(meth)acrylate, pentaerythritol tetra(meth)acrylate, ditrimethylolpropane tetra(meth)acrylate, dipentaerythritol tetra(meth)acrylate, dipentaerythritol penta (meth)acrylate, dipentaerythritol hexa (meth)acrylate, and caprolactone-modified tris [(meth)acryloyloxyethyl] isocyanurate.

From the viewpoint of adjusting the Young's modulus of the resin layer, the photopolymerizable compound may contain a polyfunctional monomer modified with alkylene oxide. The polyfunctional monomer modified with alkylene oxide may have at least one selected from the group consisting of an ethylene oxide (EO) chain and a propylene oxide (PO) chain. The ethylene oxide chain can be expressed as “(EO)n” and the propylene oxide chain can be expressed as “(PO)n”. n is an integer of 1 or more, may be 2 or more or 3 or more, and may be 30 or less, 25 or less, or 20 or less. Examples of the polyfunctional monomer modified with alkylene oxide include alkylene oxide-modified di(meth)acrylate and alkylene oxide-modified tri(meth)acrylate.

Examples of the alkylene oxide-modified di(meth)acrylate include polyethylene glycol di(meth)acrylate, isocyanuric acid ethylene oxide-modified di(meth)acrylate, ethylene oxide-modified bisphenol F di(meth)acrylate, ethylene oxide-modified bisphenol A di(meth)acrylate, polypropylene glycol di(meth)acrylate, propylene oxide-modified bisphenol A di(meth)acrylate, and propylene oxide-modified neopentyl glycol di(meth)acrylate.

Examples of the alkylene oxide-modified tri(meth)acrylate include trimethylolpropane tri(meth)acrylate, trimethyloloctane tri(meth)acrylate, trimethylolpropane polyethoxy tri(meth)acrylate, trimethylolpropane polypropoxy tri(meth)acrylate, trimethylolpropane polyethoxy polypropoxy tri(meth)acrylate, tris [(meth)acryloyloxyethyl] isocyanurate, and pentaerythritol tri(meth)acrylate.

The photopolymerization initiator can be appropriately selected from known radical photopolymerization initiators for use. Examples of the photopolymerization initiator include 1-hydroxycyclohexyl phenyl ketone (Omnirad 184, manufactured by IGM Resins B.V.), 2,2-dimethoxy-2-phenylacetophenone, 1-(4-isopropylphenyl)-2-hydroxy-2-methylpropane-1-one, bis(2,6-dimethoxybenzoyl)-2,4,4-trimethylpentylphosphine oxide, 2-methyl-1-[4-(methylthio)phenyl]-2-morpholino-propane-1-one (Omnirad 907, manufactured by IGM Resins B.V.), 2,4,6-trimethylbenzoyl diphenylphosphine oxide (Omnirad TPO H, manufactured by IGM Resins B.V.), ethyl phenyl(2,4,6-trimethylbenzoyl)phosphinate (Omnirad TPO-L, manufactured by IGM Resins B.V.), tri [phenyl(2,4,6-trimethylbenzoyl)phosphinic acid] polyethylene glycol ester (Omnipol TP, manufactured by IGM Resins B.V.), and bis(2,4,6-trimethylbenzoyl)phenylphosphine oxide (Omnirad 819, manufactured by IGM Resins B.V.).

The content of the photopolymerization initiator may be 1 part by mass or more and 10 parts by mass or less, 2 parts by mass or more and 8 parts by mass or less, or 3 parts by mass or more and 7 parts by mass or less, with respect to 100 parts by mass of the total amount of the photopolymerizable compound/From the viewpoint of the lateral pressure resistance of the optical

fiber, the resin composition according to the present embodiment may further contain a polydimethylsiloxane compound. The polydimethylsiloxane compound is a compound having, as a repeating unit, a dimethylsiloxane skeleton (—Si(CH₃)₂O—) configured by two methyl groups and the oxygen atom bonded to the silicon atom in the main chain.

From the viewpoint of lateral pressure resistance, the amount of silicon atom (Si) contained in the polydimethylsiloxane compound may be 6% by mass or more, 8% by mass or more, 10% by mass or more, or 12% by mass or more. From the viewpoint of the stability of the resin composition, the amount of Si may be 40% by mass or less, 30% by mass or less, 25% by mass or less, or 21% by mass or less. The amount of Si contained in the polydimethylsiloxane compound can be measured by inductively coupled plasma optical emission spectrometry (ICP-OES) of the polydimethylsiloxane compound.

From the viewpoint of lateral pressure resistance and hot water resistance, the polydimethylsiloxane compound may have at least one organic group selected from the group consisting of a (meth)acryloyl group, an epoxy group, and a polyether group. That is, from the viewpoint of lateral pressure resistance and hot water resistance, the polydimethylsiloxane compound may contain at least one selected from the group consisting of a polydimethylsiloxane compound having a (meth)acryloyl group, a polydimethylsiloxane compound having an epoxy group, and a polydimethylsiloxane compound having a polyether group. The polydimethylsiloxane compound may have these organic groups at a side chain or a terminal. Among these organic groups, from the viewpoint of lateral pressure resistance and hot water resistance, a (meth)acryloyl group and an epoxy group are preferred, and a (meth)acryloyl group is more preferred.

The polydimethylsiloxane compound having a (meth)acryloyl group can be copolymerized with the above-described photopolymerizable compound. The polydimethylsiloxane compound having a (meth)acryloyl group is not included in the above-described photopolymerizable compound. The number of (meth)acryloyl groups of the polydimethylsiloxane compound may be 1 or more or 2 or more, and may be 10 or less or 8 or less. The number of epoxy groups of the polydimethylsiloxane compound may be 1 or more or 2 or more, and may be 10 or less or 8 or less. The number of polyether groups of the polydimethylsiloxane compound may be 1 or more or 2 or more, and may be 10 or less or 8 or less.

From the viewpoint of lateral pressure resistance and hot water resistance, the content of the polydimethylsiloxane compound may be 0.5 parts by mass or more and 5.0 parts by mass or less, 1.0 part by mass or more and 4.0 parts by mass or less, or 1.5 parts by mass or more and 3.0 parts by mass or less, with respect to 100 parts by mass of the total amount of the photopolymerizable compound.

The resin composition according to the present embodiment may further contain a silane coupling agent, a leveling agent, an antifoaming agent, an antioxidant, a sensitizer, and the like.

The silane coupling agent is not particularly limited as long as it causes no inhibition in curing of the resin composition. Examples of the silane coupling agent include tetramethyl silicate, tetraethyl silicate, mercaptopropyl trimethoxysilane, vinyltrichlorosilane, vinyltriethoxysilane, vinyltris(β-methoxy-ethoxy) silane, β-(3,4-epoxylcyclohexyl)-ethyltrimethoxysilane, dimethoxydimethylsilane, diethoxydimethylsilane, 3-acryloxypropyl trimethoxysilane, γ-glycidoxypropyl trimethoxysilane, γ-glycidoxypropylmethyl diethoxysilane, γ-methacryloxypropyl trimethoxysilane, N—(β-aminoethyl)-γ-aminopropyl trimethoxysilane, N—(β-aminoethyl)-γ-aminopropyltrimethyl dimethoxysilane, N-phenyl-γ-aminopropyl trimethoxysilane, γ-chloropropyl trimethoxysilane, γ-mercaptopropyl trimethoxysilane, γ-aminopropyl trimethoxysilane, bis-[3-(triethoxysilyl) propyl] tetrasulfide, bis-[3-(triethoxysilyl) propyl] disulfide, γ-trimethoxysilylpropyl dimethylthiocarbamoyl tetrasulfide, and γ-trimethoxysilylpropyl benzothiazyl tetrasulfide.

The viscosity at 25° C. of the resin composition according to the present embodiment may be 1000 mPa·s or more, 1500 mPa·s or more, or 2000 m·Pas or more from the viewpoint of storage stability, and may be less than 10000 mPa·s, 8000 mPa·s or less, or 6000 mPa·s or less from the viewpoint of coatability.

From the viewpoint of improving the single fiber separability of the optical fiber, the Young's modulus of the resin film when the resin composition is cured by ultraviolet rays under the condition of 1000+100 mJ/cm² may be 500 MPa or more, 600 MPa or more, or 700 MPa or more at 23° C. From the viewpoint of forming a resin layer excellent in toughness, the Young's modulus of the resin film may be 1500 MPa or less, 1400 MPa or less, or 1300 MPa or less at 23° C.

The resin composition according to the present embodiment can be suitably used as a colored coating material for an optical fiber. By forming an outermost layer of the coating resin layer using the colored coating material containing the resin composition according to the present embodiment, an optical fiber in which color peeling is less likely to occur can be produced.

### (Optical Fiber)

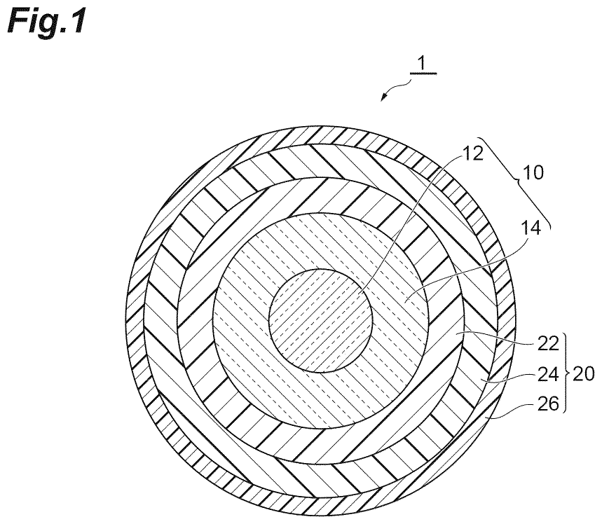

FIG. 1 is a schematic cross-sectional view illustrating a configuration of an optical fiber according to an embodiment. As illustrated in FIG. 1, an optical fiber 1 of the present embodiment includes a glass fiber 10 and a coating resin layer 20 being in contact with the glass fiber 10 and covering an outer periphery of the glass fiber 10.

The glass fiber 10 is a light guiding optical transmission medium that transmits light introduced to the optical fiber 1. The glass fiber 10 is a member made of glass, and includes, for example, silica (SiO₂) glass as a base material (main component). The glass fiber 10 includes a core 12 and a cladding 14 covering the core 12. The glass fiber 10 transmits light introduced to the optical fiber 1. The core 12 is provided, for example, in an area including a center axis line of the glass fiber 10. The core 12 is formed of, for example, pure SiO₂ glass, or SiO₂ glass containing germanium dioxide (GeO₂), a fluorine element, or the like. The cladding 14 is provided in an area surrounding the core 12. The cladding 14 has a refractive index lower than a refractive index of the core 12. The cladding 14 is formed of, for example, pure SiO₂ glass, or SiO₂ glass added with a fluorine element. The outer diameter of the glass fiber 10 is about 100 μm to 125 μm, and the diameter of the core 12 included in the glass fiber 10 is about 7 μm to 15 μm.

The coating resin layer 20 is an ultraviolet curable resin layer covering the cladding 14. The coating resin layer 20 includes a primary resin layer 22 coating an outer periphery of the glass fiber 10, a secondary resin layer 24 coating an outer periphery of the primary resin layer 22, and a colored resin layer 26 coating an outer periphery of the secondary resin layer 24. The primary resin layer 22 is in contact with an outer peripheral surface of the cladding 14 and coats the entire cladding 14. The secondary resin layer 24 is in contact with an outer peripheral surface of the primary resin layer 22 and coats the entire primary resin layer 22. The colored resin layer 26 is in contact with an outer peripheral surface of the secondary resin layer 24 and coats the outer periphery of the secondary resin layer 24.

The thickness of the primary resin layer 22 is, for example, 10 μm or more and 50 μm or less. The thickness of the secondary resin layer 24 is, for example, 10 μm or more and 40 μm or less. The thickness of the colored resin layer 26 is, for example, 3 μm or more and 10 μm or less.

The primary resin layer 22 may be formed by using a conventional known resin composition for a primary resin layer. The primary resin layer 22 can be formed, for example, by curing a resin composition containing urethane (meth)acrylate, a monomer, a photopolymerization initiator, and a silane coupling agent.

The secondary resin layer 24 may be formed by using a conventional known resin composition for a secondary resin layer. The secondary resin layer 24 can be formed, for example, by curing a resin composition containing urethane (meth)acrylate, a monomer, and a photopolymerization initiator.

The resin composition according to the present embodiment can be applied to the colored resin layer 26. The colored resin layer 26 can be formed by curing the above-described resin composition. When the colored resin layer 26 contains a cured product of the resin composition according to the present embodiment, it is possible to make occurrence of color peeling of the optical fiber difficult.

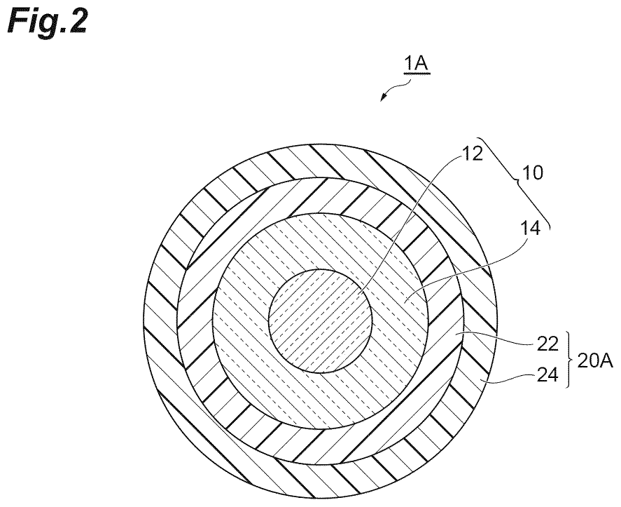

FIG. 2 is a schematic cross-sectional view illustrating a configuration of an optical fiber according to an embodiment. As illustrated in FIG. 2, an optical fiber 1A includes a glass fiber 10 and a coating resin layer 20A being in contact with the glass fiber 10 and covering an outer periphery of the glass fiber 10. The coating resin layer 20A includes a primary resin layer 22 and a secondary resin layer 24. The resin composition according to the present embodiment can be applied to the secondary resin layer 24. The secondary resin layer 24 can be formed by curing the above-described resin composition. In this case, the secondary resin layer 24 functions as a colored secondary resin layer. When the secondary resin layer 24 contains a cured product of the resin composition according to the present embodiment, it is possible to make occurrence of color peeling of the optical fiber difficult.

### (Optical Fiber Ribbon)

An optical fiber ribbon using the optical fiber according to the present embodiment can be produced. In the optical fiber ribbon, a plurality of the above-described optical fibers are arranged in parallel and coated with a ribbon resin.

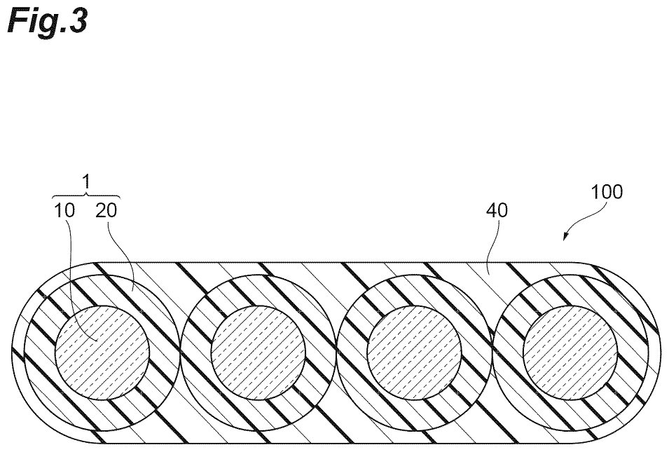

FIG. 3 is a schematic cross-sectional view illustrating an optical fiber ribbon according to the present embodiment. An optical fiber ribbon 100 includes a plurality of optical fibers 1, and a connecting resin layer 40 in which the optical fibers 1 are coated with a ribbon resin and connected. In FIG. 3, as an example, four optical fibers are illustrated, but the number thereof is not particularly limited.

As the ribbon resin, a resin material generally known as a ribbon material can be used. From the viewpoint of damage preventing property, dividing easiness, and the like of the optical fiber, the ribbon resin may include a thermosetting resin such as a silicone resin, an epoxy resin, or a urethane resin, or an ultraviolet curable resin such as epoxy acrylate, urethane acrylate, or polyester acrylate.

By the optical fiber ribbon according to the present embodiment using the above-described optical fiber, when an operation of taking out the optical fiber by removing the connecting resin layer from the optical fiber ribbon, color peeling does not occur, and the optical fiber can be easily identified.

### Examples

The following will describe the present disclosure in further detail with showing results of evaluation tests using Examples and Comparative Examples according to the present disclosure. Note that, the present disclosure is not limited to these Examples.

### [Resin Composition for Colored Resin]

The following components were prepared in order to prepare a resin composition for a colored resin.

### (Photopolymerizable Compound)

EA: bisphenol A epoxy diacrylate
PPGDA: polypropylene glycol diacrylate (PO number: 3)
TMP (EO);TA: trimethylolpropane EO-added triacrylate (EO number: 3)
TMP (EO) 15TA: trimethylolpropane EO-added triacrylate (EO number: 15)
BPA (EO) 30DA: EO-modified bisphenol A di(meth)acrylate (EO number: 30)

### (Photopolymerization Initiator)

Omnirad 184:1-hydroxycyclohexyl phenyl ketone
Omnirad TPO H: 2,4,6-trimethylbenzoyl diphenylphosphine oxide (Copper phthalocyanine particles)
A1: copper phthalocyanine particles surface-treated with a rosin compound containing abietic acid as a main component (average particle diameter: 100 nm, amount of the surface-treated layer: 5% by mass)
A2: copper phthalocyanine particles surface-treated with a rosin compound containing dehydroabietic acid as a main component (average particle diameter: 100 nm, amount of the surface-treated layer: 5% by mass)
A3: copper phthalocyanine particles surface-treated with a rosin compound containing tetrahydroabietic acid as a main component (average particle diameter: 100 nm, amount of the surface-treated layer: 5% by mass)
A4: copper phthalocyanine particles not surface-treated (average particle diameter: 100 nm)

### (Polydimethylsiloxane Compound)

PDMS: polydimethylsiloxane compound having a Si amount of 21% by mass

### Test Examples 1 to 6

Resin compositions were prepared by mixing the photopolymerizable compound, the photopolymerization initiator, and the polydimethylsiloxane compound in the blending amounts (parts by mass) shown in Table 1 with the copper phthalocyanine particles in the blending amount (% by mass) shown in Table 1. Note that, the content of the copper phthalocyanine particles is a numerical value based on the total amount of the resin composition. Test Examples 1 to 5 correspond to Examples, and Test Example 6 corresponds to Comparative Example.

### (Young's Modulus)

A resin composition was applied onto a polyethylene terephthalate (PET) film using a spin coater, and then cured using an electrodeless UV lamp system (“VPS600 (D bulb)” manufactured by Heraeus K. K.) under the condition of 1000±100 mJ/cm² to form a resin layer having a thickness of 50±5 μm on the PET film. The resin layer was peeled off from the PET film to obtain a resin film.

The resin film was punched into a dumbbell shape of JIS K 7127 Type 5, and pulled under the conditions of 23±2° C. and 50±10% RH using a tensile tester at a tension rate of 1 mm/min and a gauge line distance of 25 mm to obtain a stress-strain curve. The Young's modulus of the film was determined from a 2.5% secant line.

### (Dispersibility)

A measurement solution was prepared by adding 1 mL of a diluted solution, which was obtained by diluting 1 g of the resin composition with 50 mL of methyl ethyl ketone, to 100 mL of an electrolyte (methyl ethyl ketone solution containing 2% by mass of sodium thiocyanate). The number of particles (aggregated particles of copper phthalocyanine particles) having a particle diameter of 5 μm or more contained in 100 mL of the measurement solution was measured using a measuring apparatus (manufactured by Beckman Coulter, Inc., product name: Multisizer 4e, aperture: 50 μm) by Coulter counter principle. As the number of particles having a particle diameter of 5 μm or more is smaller, it means that the dispersibility of the copper phthalocyanine particles is favorable.

### [Resin Composition for Primary Resin Layer]

Urethane acrylate obtained by reacting polypropylene glycol having a molecular weight of 4000, isophorone diisocyanate, hydroxyethyl acrylate, and methanol was prepared. 75 parts by mass of this urethane acrylate, 12 parts by mass of nonylphenol EO-modified acrylate, 6 parts by mass of N-vinylcaprolactam, 2 parts by mass of 1,6-hexanediol diacrylate, 1 part by mass of Omnirad TPO H, and 1 part by mass of 3-mercaptopropyl trimethoxysilane were mixed to prepare a resin composition P.

### [Resin Composition for Secondary Resin Layer]

Urethane acrylate obtained by reacting polypropylene glycol having a molecular weight of 600, 2,4-tolylene diisocyanate, and 2-hydroxyethyl acrylate was prepared. 40 parts by mass of this urethane acrylate, 35 parts by mass of isobornyl acrylate, 24 parts by mass of epoxy acrylate, as an acrylic acid adduct of bisphenol A diglycidyl ether, 1 part by mass of Omnirad TPO H, and 1 part by mass of Omnirad 184 were mixed to prepare a resin composition S.

### [Resin Composition for Ribbon]

Urethane acrylate A obtained by reacting bisphenol A-ethylene oxide addition diol, tolylene diisocyanate, and hydroxyethyl acrylate and urethane acrylate B obtained by reacting polytetramethylene glycol, tolylene diisocyanate, and hydroxyethyl acrylate were prepared. 18 parts by mass of urethane acrylate A, 10 parts by mass of urethane acrylate B, parts by mass of tricyclodecanedimethanol diacrylate, 10 parts by mass of N-vinylpyrrolidone, 10 parts by mass of isobornyl acrylate, 5 parts by mass of bisphenol A-ethylene oxide addition diol diacrylate, 0.7 parts by mass of 2-methyl-1-[4-(methylthio)phenyl]-2-morpholino-propane-1-one (Omnirad 907), and 1.3 parts by mass of Omnirad TPO H were mixed to prepare a resin composition R.

### [Production of Optical Fiber]

A primary resin layer having a thickness of 35 μm was formed using the resin composition P on the outer periphery of the glass fiber having a diameter of 125 μm, and a secondary resin layer having a thickness of 25 μm was further formed using the resin composition S on the outer periphery thereof, thereby producing an optical fiber. Next, after temporarily winding the optical fiber, a colored resin layer having a thickness of 5 μm was formed using the resin composition of each of Test Examples 1 to 6 on the outer periphery of the secondary resin layer while feeding out the optical fiber again by a coloring machine, thereby producing an optical fiber (hereinafter, referred to as “colored optical fiber”) having a diameter of 255 μm and having the colored resin layer. The linear speed at the time of forming each resin layer was set to 1500 m/min.

### [Production of Optical Fiber Ribbon]

Four colored optical fibers were prepared, the resin composition R for a ribbon was coated, and the resin composition was then cured by irradiation with ultraviolet rays to form a connecting resin layer, thereby producing an optical fiber ribbon.

### (Color Peeling Test)

The optical fiber ribbon was stored in an environment (dark place) at 85° C. and 85% RH for 120 days, and then the optical fibers were separated into individual optical fibers from the optical fiber ribbon in accordance with Telcordia GR-20 5.3.1. The presence and absence of peeling of the colored resin layer at this time were evaluated. A case where there was no peeling in the colored resin layer was evaluated as “A”, a case where a part of the ribbon resin remained in the colored resin layer was evaluated as “B”, and a case where there was peeling in the colored resin layer was evaluated as “C”.

TABLE 1

| Test Example | | 1 | 2 | 3 | 4 | 5 | 6 |
|---|---|---|---|---|---|---|---|
| Copper | Type | A1 | A1 | A1 | A2 | A3 | A4 |
| phthalocyanine | % by mass | 1 | 3 | 5 | 5 | 5 | 5 |
| particles | | | | | | | |
| EA | parts by | 55 | 55 | 55 | 55 | 55 | 55 |
| PPGDA | mass | 15 | 15 | 15 | 15 | 15 | 15 |
| TMP(EO)₃TA | | 10 | 10 | 10 | 10 | 10 | 10 |
| TMP(EO)₁₅TA | | 10 | 10 | 10 | 10 | 10 | 10 |
| BPA(EO)₃₀DA | | 10 | 10 | 10 | 10 | 10 | 10 |
| PDMS | | 2 | 2 | 2 | 2 | 2 | 2 |
| Omnirad 184 | | 5 | 5 | 5 | 5 | 5 | 5 |
| Omnirad TPO H | | 1 | 1 | 1 | 1 | 1 | 1 |

| | | | | | | |
|---|---|---|---|---|---|---|
| Young's modulus (MPa) | 1200 | 1100 | 1000 | 1000 | 1000 | 1000 |
| Number of particles of 5 | 2 | 9 | 15 | 20 | 18 | 60 |
| μm or more | | | | | | |
| Color peeling test | A | A | A | A | A | C |

What is claimed is:

1. A resin composition for optical fiber coating, the resin composition comprising a photopolymerizable compound, a photopolymerization initiator, and surface-treated copper phthalocyanine particles,
wherein a content of the surface-treated copper phthalocyanine particles is 0.1% by mass or more and 10% by mass or less based on the total amount of the resin composition.

2. The resin composition according to claim 1, wherein the surface-treated copper phthalocyanine particles have a surface-treated layer derived from a rosin compound containing at least one selected from the group consisting of abietic acid, dehydroabietic acid, and tetrahydroabietic acid.

3. The resin composition according to claim 1, wherein an amount of the surface-treated layer in the surface-treated copper phthalocyanine particles is 1% by mass or more and 20% by mass or less.

4. The resin composition according to claim 1, wherein the photopolymerizable compound contains epoxy di(meth)acrylate.

5. A colored coating material for an optical fiber, comprising the resin composition according to claim 1.

6. An optical fiber comprising:
a glass fiber including a core and a cladding;
a primary resin layer being in contact with the glass fiber and coating the glass fiber;
a secondary resin layer coating the primary resin layer; and
a colored resin layer coating the secondary resin layer,
wherein the colored resin layer contains a cured product of the resin composition according to claim 1.

7. An optical fiber comprising:
a glass fiber including a core and a cladding;
a primary resin layer being in contact with the glass fiber and coating the glass fiber; and
a secondary resin layer coating the primary resin layer,
wherein the secondary resin layer contains a cured product of the resin composition according to claim 1.

8. An optical fiber ribbon in which a plurality of optical fibers according to claim 6 are arranged in parallel and coated with a ribbon resin.

9. An optical fiber ribbon in which a plurality of optical fibers according to claim 7 are arranged in parallel and coated with a ribbon resin.
